(19) United States
(12) Patent Application Publication
(10) Pub. No.: US 2004/0224700 A1
(43) Pub. Date: Nov. 11, 2004

(54) Image processing server

(76) Inventor: Tetsuya Sawano, Saitama (JP)

Correspondence Address: BIRCH STEWART KOLASCH & BIRCH, PO BOX 747, FALLS CHURCH, VA, 22040-0747, US

(21) Appl. No.: 10/824,439

(22) Filed: Apr. 15, 2004

(30) Foreign Application Priority Data
Apr. 22, 2003 (JP) P2003-117106

(51) Int. Cl. G06F 7/00; G01M 17/00; G06F 19/00

(52) U.S. Cl. 455/456.1; 455/422.1; 455/404.2

(57) ABSTRACT

An image processing server capable of improving the usability for the editing of image data derived by a mobile communication device having an image sensor. The image processing server is provided with a communicator for receiving from a mobile communication device an E-mail attached with image data; a position information database for storing position information about a base stations; a position specifier for specifying the position of the mobile communication device being a sender of the E-mail; an Exif tag adder for adding an Exif to the image data; and a position information adder for providing the Exif tag with attribute information of the image data, i.e., position information indicating the position of the mobile communication device specified by the position specifier.

### FIELD OF THE INVENTION

The present invention relates to an image processing server for processing image data that is provided by a mobile communication device.

### BACKGROUND OF THE INVENTION

Related art digital still cameras and portable phones with the GPS (Global Positioning System) capability have been in the market for use as mobile communication devices. In such related art systems, image data is additionally provided with its attribute information, i.e., its position information indicating where the image data was derived. This related art capability has improved the usability when organizing or distributing the image data.

One proposed related art device is an image-sensed section for recording day and time when the image data has been derived on a detachable recording medium together with the image data, and a coordinates information recording section for recording coordinates information about the user's position together with day and time. Those components are carried by the user.

After the recording medium is detached from the image-sensed section, a general-purpose computer or the like is used to correspond the image data recorded on the recording medium to the position information using information about day and time as a key. As an example, Japanese patent document, JP-A-2001-28728 (hereafter “JPA '728”) deals with the foregoing related art issue.

However, the invention has various problems and disadvantages. For example, but not by way of limitation, image data derived by any mobile communication device having no such GPS capability does not indicate where the image has been picked up. Thus, the user cannot determine position information in those cases. The mobile communication device may store such position information in a file separately from the image data. If this is the case, however, correspondence between those data is easily lost, causing inconvenience with the editing of the image data.

Further, JPA '728 requires the user to carry around the image pick-up section and the coordinates information recording section, and this is considered inconvenient.

### SUMMARY OF THE INVENTION

The present invention is proposed in consideration of the above circumstances, and an object thereof is to provide an image processing server capable of improving the usability for the editing of image data derived by a mobile communication device(e.g. cellular communication device such as cellular phone and PDA, and mobile computer) having an image sensor (e.g. image pickup device or image capturing device). However, the present invention is not limited to such an object, nor must such an object, or any object, be achieved for the implementation of the present invention.

Accordingly, the image processing server of the present invention is provided with a specifier that specifies a position of a mobile communication device based on information from a base station representing a communication region, after the image processing server receives image data sensed by the mobile communication device having an image sensor; and an adder that adds first position information indicative of the specified position to the image data as attribute information of the image data.

In addition, the image processing server of the present invention is provided with means for specifying a position of a mobile communication device based on information from a base station representing a communication region, after the image processing server receives image data sensed by the mobile communication device having an image sensor; and means for adding first position information indicative of the specified position to the image data as attribute information of the image data. The first position information includes at least one of global positioning system (GPS) information, address information and a place name.

With such a structure, image data added with attribute information including position information indicating where the image has been sensed is derived in the following manner. The user of a mobile communication device senses the image of an object, and the resulting image data is transmitted to an image processing server from the image-sensed site(i.e. position information of a position where the image is sensed). Accordingly, with any type of a mobile communication device, the usability can be successfully improved for the case of editing the resulting image data derived by the mobile communication device.

In the image processing server of the present invention, the specifier specifies the position of the mobile communication device based on second position information of the base station, the base station being used in transmitting the image data; and the adder adds global positioning system (GPS) information of the base station to the image data, based on a database storing the second position information of the base station and the GPS information associated with the second position information.

In addition, In the image processing server of the present invention, the means for specifying specifies the position of the mobile communication device based on second position information of the base station, the base station being used in transmitting the image data; and the means for adding adds global positioning system (GPS) information of the base station to the image data, based on a database storing the second position information of the base station and the GPS information associated with the second position information. The second position information includes a base station number of the base station.

With such a structure, detailed information about an image-sensed site can be provided in a corresponding manner to image data.

The image processing server of the present invention is provided with an adder that adds third position information indicative of a position where an image sensor in a mobile communication device sensed image data, to the image data sensed by the image sensor as attribute information of the image data, after the image processing server receives the image data and fourth position information where the image sensor sensed the image data, from the mobile communication device

In addition, the image processing server of the present invention is provided with means for adding third position information indicative of a position where an image sensor in a mobile communication device sensed image data, to the image data sensed by the image sensor as attribute information of the image data, after the image processing server receives the image data and fourth position information where the image sensor sensed the image data, from the mobile communication device. The third position information includes at least one of global positioning system (GPS) information, address information and a place name, and the fourth position information includes at least one of a base station number and a place name, obtained from a base station.

With such a structure, image data added with attribute information, i.e., position information indicating where the image has been sensed, is derived in the following manner. That is, the user of a mobile communication device senses the image of an object, and the resulting image data is transmitted to an image processing server together with position information indicating where the object image has been sensed. Accordingly, with any type of a mobile communication device, the usability can be successfully improved for the case of editing the resulting image data derived by the mobile communication device.

Further, in the image processing server of the present invention, the adder adds the position information to an Exif tag of the image data.

With such a structure, the position information is provided to an Exif tag that is defined by the Exif specification and is a standard option for digital cameras and other devices, successfully improving the usability for the editing of image data.

When the image data has no such an Exif tag, the image processing server of the present invention includes an Exif tag adder for adding the Exif tag to the image data.

With such a structure, image data that does not conform to the Exif specification is added with the Exif tag, allowing services to be flexible on a mobile communication device basis.

### BRIEF DESCRIPTION OF THE DRAWINGS

The above and other objects and advantages of the present invention will become more apparent by describing in detail exemplary, non-limiting embodiments thereof with reference to the accompanying drawings, wherein like reference numerals designate like or corresponding parts throughout the several views, and wherein:

FIG. 1 illustrates a diagram showing the schematic diagram of an image processing system for illustrating a first exemplary, non-limiting embodiment of the present invention;

FIG. 2 illustrates a diagram showing exemplary, non-limiting position information of base stations to be stored in a position information database provided in an image processing server of the image processing system of the first embodiment of the present invention;

FIG. 3 illustrates a diagram showing exemplary, non-limiting information recordable onto an Exif tag according to the present invention;

FIG. 4 illustrates an operation flow of the image processing server of the image processing system according to the first embodiment of the present invention;

[FIG. 5]

FIGS. 5A and 5B illustrate usage of image data processed by the image processing server of the image processing system of the first embodiment of the present invention;

FIG. 6 illustrates the schematic structure of the image processing system for a second exemplary, non-limiting embodiment of the present invention; and

FIG. 7 illustrates a diagram showing an exemplary, non-limiting display of a head part of an E-mail created by a mobile communication device of the image processing system of the second embodiment of the present invention.

### DETAILED DESCRIPTION OF THE INVENTION

The exemplary, non-limiting embodiments of the present invention will be described below with reference to the accompanying drawings.

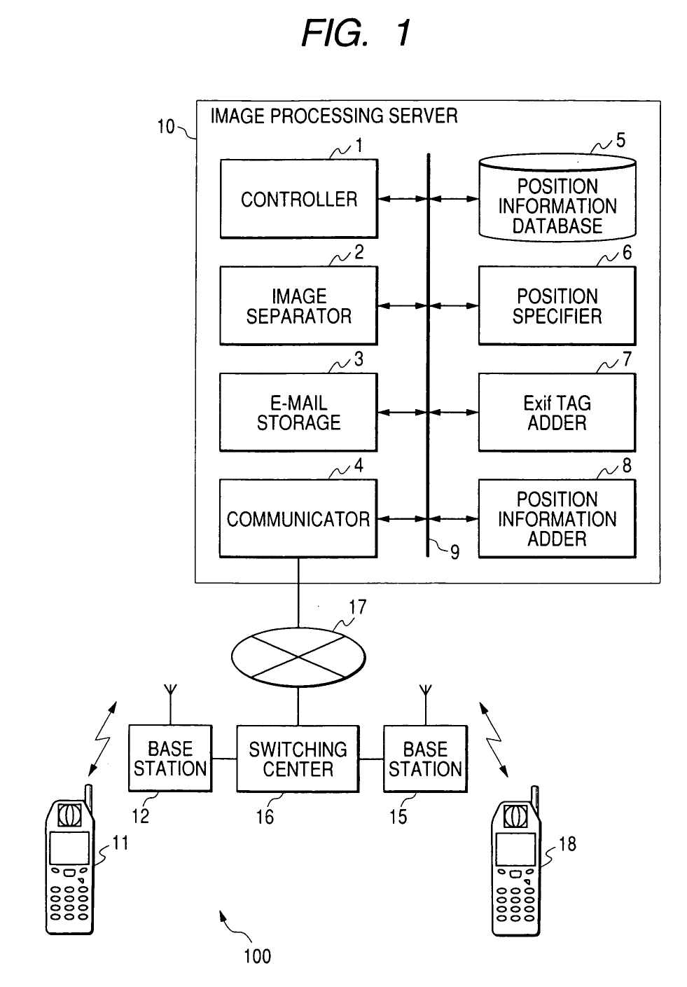

FIG. 1 is a diagram showing the schematic structure of system 100 for processing an input received from a mobile communication device, for illustrating an exemplary, non-limiting first embodiment of the present invention.

The image processing system 100 includes: mobile communication devices 11 and 18 both exemplified by a portable phone having an image sensor such as charge coupled device (CCD) and complementary metal-oxide semiconductor (CMOS); base stations 12 and 15 structuring a communications area; a switching center 16 for exercising overall control over the base stations 12 and 15; a network 17 exemplified by the Internet to be connected to the switching center 16; and an image processing server 10 for adding position information to image data received from the mobile communication device 11 or 18.

The image processing server 10 is provided with: a controller 1 for exercising control over other components; an image separator 2 for image data separation from image data, for example but not by way of limitation, an electric mail (electronic mail is used as an example of digital information mail in this specification, hereinafter referred to as E-mail) attached with image data; an E-mail storage 3 for storing the E-mail having been subjected to image data separation by the image separator 2; a communicator 4; a position information database 5 for storing position information of the base stations 12 and 15; a position specifier 6 for specifying the position of the mobile communication device sending the E-mail; an Exif tag adder 7 for adding an Exif (Exchangeable Image File Format) tag to the image data; a position information adder 8 for providing the Exif tag of the image data with attribute information of the image data, i.e., position information indicating the position of the mobile communication device specified by the position specifier 6; and a bus 9 for component connection. The mobile communication device 11 is on the transmission side of an E-mail, and the mobile communication device 18 is on the reception section thereof.

The communicator 4 is connected over the network 17 to receive E-mails coming from the mobile communication device 11. The communicator 4 also transmits, to the mobile communication device 18, E-mails stored in the E-mail storage 3 after adding thereto image data including position information provided by the position information adder 8.

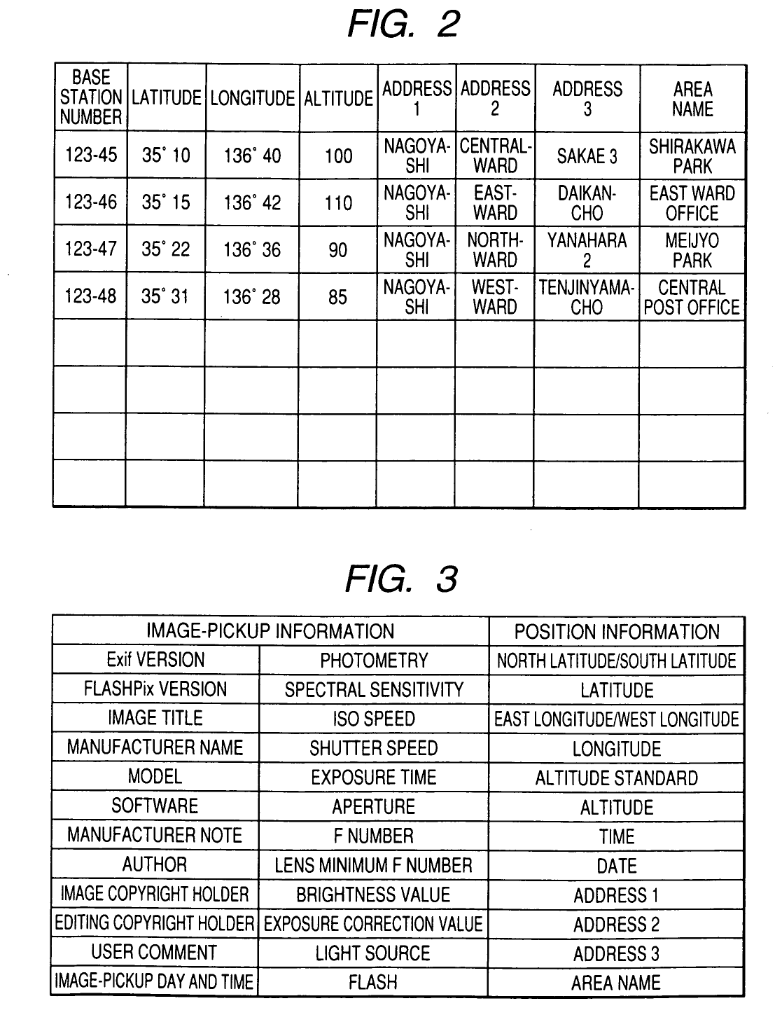

FIG. 2 is a diagram showing exemplary position information about base stations to be stored in the position information database 5. As shown in FIG. 2, the position information database 5 stores GPS information and address information in a corresponding manner to the base station numbers, e.g., 123-45, 123-46. Herein, the GPS information is the one indicating the latitude, longitude, altitude, and others of the base stations, and the address information is the one indicating addresses 1 to 3, area names, and others. However, the present invention is not limited thereto.

After receiving an E-mail from the mobile communication device 11, the position specifier 6 makes an inquiry to the switching center 16 about which base station has been used by the mobile communication device 11 for the E-mail transmission. Herein, exemplarily specified is the base station 12. After specification as such, from the switching center 16, the position specifier 6 is provided with information about thus specified base station 12, e.g., station number, rough position information. Based on thus provided information, the mobile communication device 11 is specified by position. To be specific, the position derived by the position information of the base station 12, i.e., information such as the addresses 1 to 3 of FIG. 2, is determined as the position of the mobile communication device 11.

The Exif tag adder 7 adds an Exif tag to the image data having been separated by the image separator 2. Herein, if the image data having been separated by the image separator 2 is conformed to the Exif specification, i.e., if the image data includes an Exif tag, the Exif tag adder 7 skips such Exif tag addition.

FIG. 3 is a diagram showing exemplary information that is recordable to the Exif tag. As shown in FIG. 3, the Exif tag can be recorded with information about image-sensed conditions, GPS information, and any other arbitrary information, e.g., address, area name. The information about image-sensed conditions includes day and time when the image has been picked up, exposure, shutter speed, and the like, and the GPS information is about the site where the image has been picked up such as the latitude, longitude, altitude, and others.

The position information adder 8 acquires from the position information database 5 the GPS information corresponding to the position of the mobile communication device 11, i.e., position of the base station 12, specified by the position specifier 6. Thus, acquired GPS information is then recorded to an Exif tag of the image data. At the time of this information recording, the Exif tag is not filled with its every item but only any items of higher necessity for the editing of image data, e.g., latitude, longitude, and altitude. Alternatively, out of the information stored in the position information database 5, only those relating to the image-sensed site may be recorded, e.g., address, area name.

Described next is the operation of the image processing server 10 of the exemplary, non-limiting embodiment illustrated in FIG. 1.

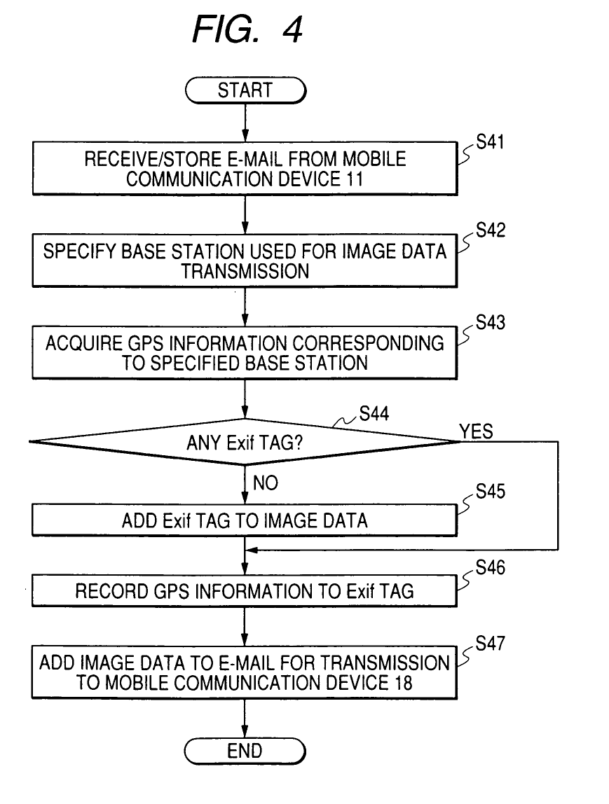

FIG. 4 is an operation flow of the image processing server 10 according to an exemplary, non-limiting embodiment of the present invention. After receiving an E-mail from the mobile communication device 11, the image processing server 10 responsively separates image data therefrom, and the resulting E-mail is stored (S41). Thereafter, a specification is made as to which base station has been used for transmission of the image data (S42).

After the base station 12 thus specified, the position information database 5 and others are used as references to acquire GPS information, e.g., latitude, longitude, and altitude, corresponding to the station number of the base station 12 (S43). Then, a determination is made whether or not the image data includes any Exif tag (S44).

When no Exif tag is included (S44: NO), the image processing server 10 accordingly adds an Exif tag to the image data (S45), and the GPS information acquired in S43 is recorded onto thus added Exif tag (S46). When the image data includes an Exif tag (S44: YES) on the other hand, the procedure goes to S46 and skips S45.

After recording the GPS information, the image processing server 10 attaches the image data to the E-mail for transmission to the mobile communication device 18 (S47).

Described next is an exemplary case where a user uses the image data thus transmitted to the mobile communication device 18 in the above manner.

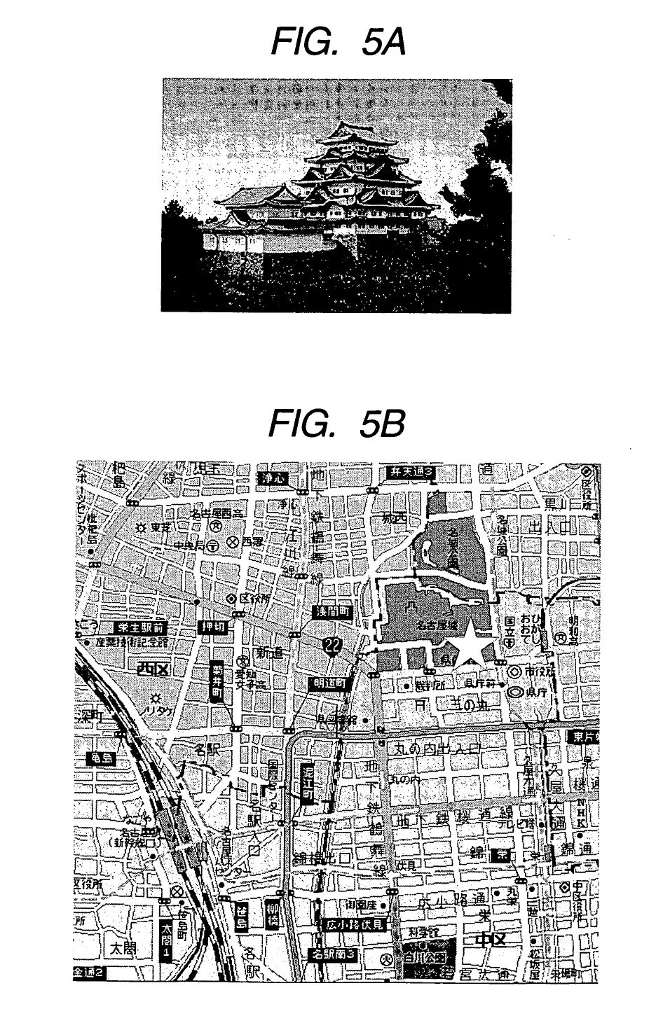

FIGS. 5A and 5B are conceptual drawings showing the usage of the image data having been processed by the image processing server 10 of the exemplary, non-limiting embodiment of the present invention. The image data of FIG. 5A includes an Exif tag having the GPS information recorded therein. By dropping the image data onto an electronic location interface, such as an electronic map on a display screen of the mobile communication device 18 or any electronic user interface such as personal computer, a star-shaped mark accordingly appears on the electronic map as shown in FIG. 5B to show where the image has been picked up. The map may include a region that is representative of at least a portion of the area where the base station is positioned. This easily tells the user where the image data has been derived at a glance.

As described in the foregoing, according to the present embodiment, an Exif tag is added to image data through transmission of E-mail from the site where an object image has been picked up. In the above example, after an object image is sensed by the user of the mobile communication device 11, the resulting image data is attached to an E-mail for transmission to the mobile communication device 18 from the image-sensed site. As a result, the Exif tag is recorded with position information about the image-sensed site before transmission to the mobile communication device 18.

The present invention has various advantages over the related art. For example, but not by way of limitation, even if the mobile communication device 11 cannot add image data with its attribute information, i.e., position information about the imagesensed site, it becomes possible to transmit, to the potable terminal 18, the image data to which position information about the image-sensed site corresponds. This benefits any type of mobile communication device in terms of the user's usability for editing of the image data. Further, there is no need for the mobile communication device 11 to have such a capability, thus reducing its manufacturing cost.

In order not to increase the communications fee for transmission and reception of image data, for example, portable phones of a general type do not have a capability of adding an Exif tag to their image data, for example. On the other hand, the image processing server 10 has a capability of adding an Exif tag to image data coming from portable phones for recording of GPS information. Accordingly, no matter from which portable phone image data comes, the image data can be added with the position information about the image-sensed site.

In the present embodiment, GPS information about an image-sensed site is recorded onto an Exif tag. This is not restrictive as long as image data and position information about the image-sensed site can be in the same file.

Further, in the present exemplary, non-limiting embodiment, the GPS information of the base station 12 is recorded onto the Exif tag. This is not also restrictive, and the Exif tag may be recorded only with address information stored in the position information database 5. This is because the image data is required to roughly indicate where the image-sensed site is located.

Still further, in the present embodiment, the position specifier 6 makes a specification that the mobile communication device 11 is located at the same position as the base station 12. Alternatively, the mobile communication device 11 may be defined by position in the following manner. That is, the position specifier 6 may acquire from the switching center 16 information about the electric field strength at each base station received from the mobile communication device 11, and accordingly calculate the distance to the mobile communication device 11.

When this is the case, a plurality of points may be set in advance on a communication region basis for a base station, and information about the latitude, longitude, altitude, and others for every point may be stored in the position information database 5. After the mobile communication device 11 is specified by position, at the point closest thereto, the mobile communication device 11 is defined as being located. Then, GPS information about the point may be recorded onto an Exif tag of the image data. In such a manner, the position of the mobile communication device 11 can be specified with accuracy, leading to the more correct image-sensed site of the image data.

### Second Embodiment

In the first embodiment, the image data is added with attribute information, i.e., position information. However, when the site where an object image is sensed is not the same as the site where the resulting image data is transmitted, the image data will be problematically added with position information about the site from where the image data has been transmitted.

In order to deal therewith, in the second embodiment, the mobile communication device 11 of FIG. 1 previously stores its own position information at the time of image-sensed, and transmits an E-mail together with the position information provided at a header part thereof. In this manner, GPS information corresponding to the position information is written into an Exif tag on the side of the image processing server.

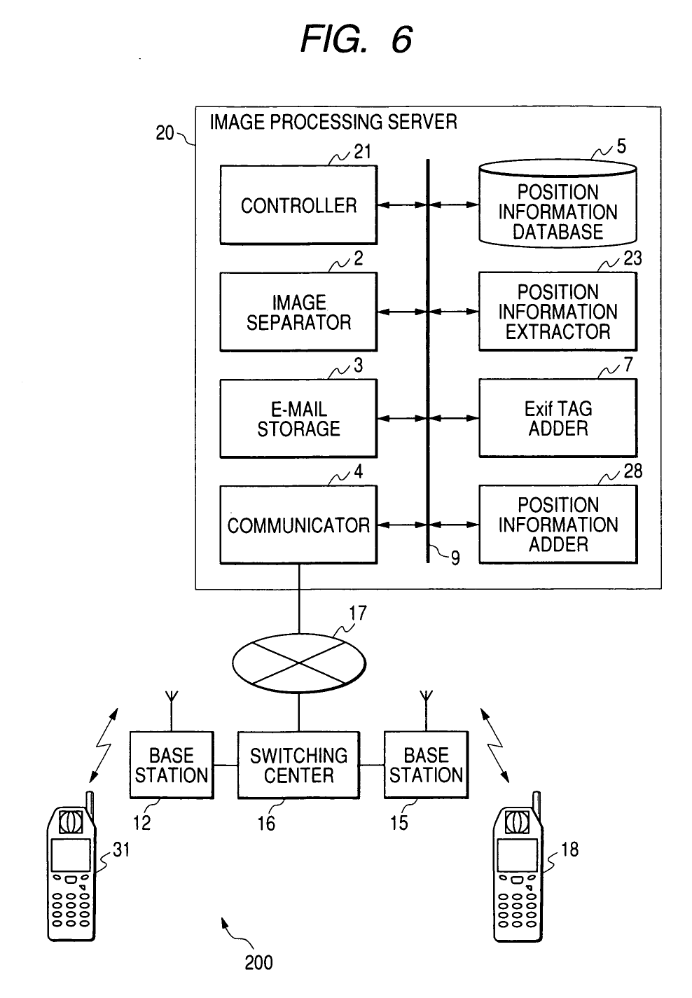

FIG. 6 is a diagram showing the schematic structure of an image processing system 200 for illustrating the second embodiment of the present embodiment. Any component same as that of FIG. 1 is provided with the same reference numeral.

The image processing system 200 includes: mobile communication devices 31 and 18 exemplified by a portable phone and others having an image sensor such as charge coupled device (CCD) and complementary metal-oxide semiconductor (CMOS); the base stations 12 and 15; the switching center 16; the network 17; and an image processing server 20 for adding position information to image data received from the mobile communication device 31 or 18.

The image processing server 20 is provided with: a controller 21 for exercising control over other components; the image separator 2; the E-mail storage 3; a position information extractor 23 for extracting position information stored in the header part of an E-mail; the communicator 4; the position information database 5; the Exif tag adder 7; a position information adder 28 for providing attribute information of the image data, i.e., information about the latitude, longitude, altitude, and others, corresponding to the position information extracted by the position information extractor 23, to an Exif tag of the image data; and the bus 9. Below, it is assumed that the mobile communication device 31 is on the transmission side of an E-mail, and the mobile communication device 18 is on the reception section thereof.

When receiving a user's request for image-sensed, the mobile communication device 31 accordingly communicates with the base station 12 locating closest to the mobile communication device 31 to receive its station number, area name, and others. This information indicates the site where the mobile communication device 31 has sensed the object image. Then, image data derived from the sensed image is attached to an E-mail for transmission to the mobile communication device 18. Before transmission, at the header part of the E-mail, the information provided by the base station 12 is attached.

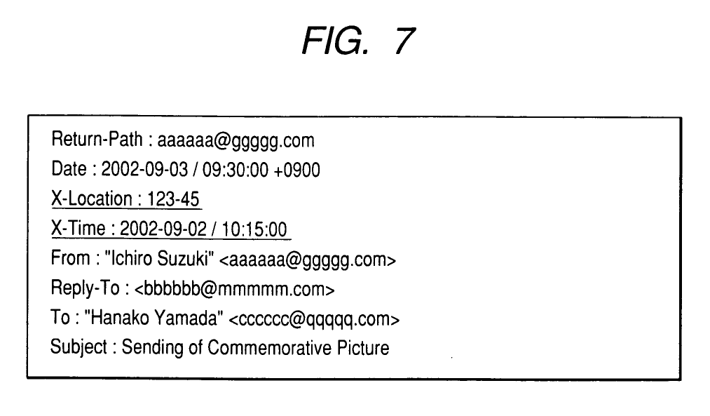

FIG. 7 is a diagram showing an exemplary display of the header part of an E-mail created by the mobile communication device 31. As shown in the drawing, the third line “X-Location” of the header part is written with the base station number “123-45” corresponding to the image-sensed site, and the fourth line “X-Time” is written with the time “2002-09-02/10:15:00” indicating the time when the image was picked up.

From the header part of the E-mail coming from the mobile communication device 31, the position information extractor 23 extracts information about the station number, the area name, and the like. In response thereto, the position information adder 28 acquires from the position information database 5 the GPS information corresponding to thus extracted information, e.g., base station number. Thus acquired information is then recorded onto an Exif tag of image data. In an alternate manner, the position information adder 28 may record the information extracted by the position information extractor 23 directly onto the Exif tag.

As described above, according to the present embodiment, an Exif tag of image data is added by the image processing server 20 with information such as latitude, longitude, and altitude corresponding to an image-sensed site, and the result is forwarded to the mobile communication device 18. Such Exif tag addition is done responding to object-image sensed by the user of the mobile communication device 31 using thereby, and image data attachment to an E-mail for transmission to the mobile communication device 18. Accordingly, even when the mobile communication device 31 does not have a capability of adding image data with its attribute information, i.e., position information about the image-sensed site, it becomes possible to transmit, to the mobile communication device 18, the image data to which position information about the mage-sensed site is corresponded. Any type of mobile communication device can increase the user's usability for editing of the image data.

In the present embodiment, the mobile communication device 31 acquires information indicating the location when image data is derived, i.e., information about the base station, and based thereon, the image data is added with position information. In this manner, the mobile communication device 18 can be provided with image data added with position information that is correctly indicating where the image data has been derived.

Here, in the present embodiment, the mobile communication device 31 is capable of acquiring position information. This is surely not restrictive, and any other mobile communication device will derive the same effects as above.

When this is the case, on a WEB site, the image processing server 20 asks a user to upload image data and position information about the site where the image data has been derived. The user accordingly manually inputs thus requested position information for uploading it to the image processing server 20 together with the image data. The image processing server 20 responsively records the position information onto an Exif tag of thus uploaded image data. In this manner, even without a capability of acquiring position information, the mobile communication device can transmit image data added with position information.

The present invention has various advantages. For example, but not by way of limitation, according to the present invention, provided is an image processing server capable of improving the usability for the editing of image data derived by a mobile communication device having an image sensor.

The present invention is not limited to the specific above-described embodiments. It is contemplated that numerous modifications may be made to the present invention without departing from the spirit and scope of the invention as defined in the following claims. The present invention claims foreign priority based on Japanese Patent application no. 2003-117106, filed on Apr. 22, 2003, the contents of which is incorporated herein by reference.

What is claimed is:

1. An image processing server, comprising:
a specifier that specifies a position of a mobile communication device based on information from a base station representing a communication region, after the image processing server receives image data sensed by the mobile communication device having an image sensor; and
an adder that adds first position information indicative of the specified position to the image data as attribute information of the image data.

2. The image processing server of claim 1, wherein the specifier that specifies the position of the mobile communication device based on second position information of the base station, the base station being used in transmitting the image data; and the adder that adds global positioning system (GPS) information of the base station to the image data, based on a database storing the second position information of the base station and the GPS information associated with the second position information.

3. The image processing server of claim 1, wherein the first position information includes at least one of global positioning system (GPS) information, address information and a place name.

4. The image processing server of claim 1, wherein the second position information includes a base station number of the base station.

5. An image processing server, comprising:
an adder that adds third position information indicative of a position where an image sensor in a mobile communication device sensed image data, to the image data sensed by the image sensor as attribute information of the image data, after the image processing server receives the image data and fourth position information where the image sensor sensed the image data, from the mobile communication device.

6. The image processing server of claim 5, wherein the third position information includes at least one of global positioning system (GPS) information, address information and a place name.

7. The image processing server of claim 5, wherein the fourth position information includes at least one of a base station number and a place name, obtained from a base station.

8. The image processing server of claim 1, wherein the adder adds the first position information to an exchangeable information file (Exif) tag of the image data.

9. The image processing server of claim 5 wherein the adder adds the third position information to an exchangeable information file (Exif) tag of the image data.

10. The image processing server of claim 8, further comprising:
an adder that adds the Exif tag to the image data when the image data received from the mobile communication device does not include the Exif tag.

11. The image processing server of claim 9, further comprising:
an adder that adds the Exif tag to the image data when the image data received from the mobile communication device does not include the Exif tag.

12. An image processing server, comprising:
means for specifying a position of a mobile communication device based on information from a base station representing a communication region, after the image processing server receives image data sensed by the mobile communication device having an image sensor; and
means for adding first position information indicative of the specified position to the image data as attribute information of the image data.

13. The image processing server of claim 12, wherein the means for specifying specifies the position of the mobile communication device based on second position information of the base station, the base station being used in transmitting the image data; and the means for adding adds global positioning system (GPS) information of the base station to the image data, based on a database storing the second position information of the base station and the GPS information associated with the second position information.

14. The image processing server of claim 12, wherein the first position information includes at least one of global positioning system (GPS) information, address information and a place name.

15. The image processing server of claim 12, wherein the second position information includes a base station number of the base station.

16. An image processing server, comprising:
means for adding third position information indicative of a position where an image sensor in a mobile communication device sensed image data, to the image data sensed by the image sensor as attribute information of the image data, after the image processing server receives the image data and fourth position information where the image sensor sensed the image data, from the mobile communication device.

17. The image processing server of claim 16, wherein the third position information includes at least one of global positioning system (GPS) information, address information and a place name.

18. The image processing server of claim 16, wherein the fourth position information includes at least one of a base station number and a place name, obtained from a base station.

19. The image processing server of claim 12, wherein the means for adding adds the first position information to an exchangeable information file (Exif) tag of the image data.

20. The image processing server of claim 16 wherein the means for adding adds the third position information to an exchangeable information file (Exif) tag of the image data.
